(19) United States
(12) Patent Application Publication
(10) Pub. No.: US 2009/0266545 A1
(43) Pub. Date: Oct. 29, 2009

(54) Method and Device for Producing a Gaseous Medium Comprising Steam

(75) Inventor: Michael Abrahamsson, Vaxholm (SE)

Correspondence Address: SCHWEGMAN, LUNDBERG & WOESSNER, P.A., P.O. BOX 2938, MINNEAPOLIS, MN, 55402, US

(73) Assignee: Steamex Group AB, Danderyd (SE)

(21) Appl. No.: 12/225,845

(22) PCT Filed: Mar. 16, 2007
(86) PCT No.: PCT/SE2007/050169

§ 371 Date: Jun. 10, 2009

(30) Foreign Application Priority Data
Mar. 30, 2006 (SE) 0600717-3

(51) Int. Cl. E21B 43/24; C09K 8/60; B01J 19/00; F02C 7/00

(52) U.S. Cl. 166/303; 507/202; 422/198; 60/39.53

(57) ABSTRACT

The invention relates to a method for producing a gaseous medium comprising steam, said steam being produced from a first fluid medium, energy for heating the first fluid medium being provided by burning a fuel, comprising the steps of mixing the steam with exhaust gas from combustion of said fuel characterised by the steps of prior to mixing the steam with exhaust gas, injecting fluid into the steam. The invention further relates to a device for producing a gaseous medium comprising steam. The invention also relates to a further method for producing a gaseous medium comprising steam The invention still further relates to a further device for producing a gaseous medium comprising steam. The invention finally relates to a turbine configuration.

### TECHNICAL FIELD

The present invention relates to a method for producing a gaseous medium comprising steam according to the preamble of claims 1. The present invention also relates to a device for producing a gaseous medium comprising steam according to the preamble of claim 5. The present invention further relates to a method for producing a gaseous medium comprising steam according to the preamble of claims 10. The present invention still further relates to a device for producing a gaseous medium comprising steam according to the preamble of claim 19. Finally the present invention relates to a turbine configuration according to claim 34.

### BACKGROUND

WO 2005/012818 discloses a method, a device and a system for heating by means of a gaseous medium comprising steam, said steam being produced from water, energy for heating the water being provided by burning a fuel, wherein the steam is mixed with exhaust gas from the combustion of said gaseous medium; and wherein said mixture is used for heating purposes.

Coal mines usually have two shafts and are located deep under ground, constituting large spaces or cavities. A problem occurs when there is a fire in a coal mine, caused e.g. by a gas explosion or the like. The fire is extremely difficult to extinguish, as it is not possible/extremely hazardous to enter the mine where the fire is. Oxygen from the air above ground is sucked into the mine by the fire, thus feeding the fire such that the fire continuously burns. There are examples of coal mines burning for several years and mines that are still burning. There is thus no satisfactory method for solving this problem today.

When there is an oil fire in an oil storage tank a similar problem of extinguishing fire occurs.

Shale oil lies under ground as bitumen. There are two known ways of extracting the oil, Either by open cut mine or by heating up the oil sand or by heating up or diluting the oil sand so that it becomes sufficiently fluid to be pumped up.

Both methods have major environmental disadvantages. Open cut mines require that two tons of tar sand is dug up for each barrel (159 litre) of oil produced. Only one fifth of the reserves of oil shale can be extracted with this technique. An army of trucks, trenching machines and bulldozers, which themselves require a lot of energy, are needed in order to excavate an area of the size of a large football ground every second day. After having extracted the shale oil the same operation is needed to fill up the open cut mine and restore nature. By using steam or chemicals for making the bitumen fluid, large risks for damaging the ground water appear. In order to extract shale oil in shale oil reserves using steam, steam is injected into the ground in order to heat up the bitumen, which then becomes fairly liquid and can be retrieved. The steam is produced by large generators, which require a lot of electrical power, making the oil very expensive. WO 2005/012818 discloses a suggestion of introducing a steam and exhaust gas mixture into the ground in order to extract the oil. This might be a good and more efficient solution, however when the oil sand is located deep under ground there may be problems transporting the mixture and preserving the energy.

A general problem with gas turbines is the cooling thereof due to high temperatures of e.g. 1300° C. There exist solutions where the exhaust gas produced during operation is used to cool the gas turbine. This is however not very efficient.

### OBJECTS OF THE INVENTION

An object of the present invention is to provide a method for producing a gaseous medium comprising steam which is efficient.

Another object of the present invention is to provide a device for producing a gaseous medium comprising steam which is efficient.

### SUMMARY OF THE INVENTION

These and other objects, apparent from the following description, are achieved by methods and devices for producing a gaseous medium comprising steam, and a turbine configuration which is of the type stated by way of introduction and which in addition exhibits the features recited in the characterising clause of the appended claims 1, 5, 10, 19 and 34. Preferred embodiments of the inventive methods, devices and systems are defined in appended sub claims 2-4, 6-9, 11-18, and 20-33.

By providing a method for producing a gaseous medium comprising steam, said steam being produced from a first fluid medium, energy for heating the first fluid medium being provided by burning a fuel, comprising the steps of mixing the steam with exhaust gas from combustion of said fuel, characterised by the step of prior to mixing the steam with exhaust gas, injecting fluid into said steam, a higher volume/amount of steam is achieved, and a steam exhaust gas mixture, i.e. steamex having a higher fluid, e.g. water, content and a lower temperature, compared to no fluid, e.g. water, injection. As a consequence of the fluid injection the dew point of the mixture is increased substantially. Thus, by varying the amount of fluid injected into the primary chamber the dew point may be varied. Having a high dew point in the steamex offers the advantage that the steamex can “carry” the energy a further distance, as there is a higher fluid, e.g. water, content in the steamex. The efficiency is thus increased. By injecting the fluid, e.g. water, as a mist preferably having a droplet size of less than 10 microns further increases the efficiency. Correspondingly, by providing a device for producing a gaseous medium comprising steam, said steam being produced from a fluid medium, for example water or oil, energy for heating the fluid medium being provided by burning a fuel, said system comprising a mixing space for mixing the steam with exhaust gas from combustion of said fuel, and supply means for transferring said steam to the mixing space, said device comprising a combustion space and means for burning said fuel, said means being arranged to heat the fluid medium in said combustion space, wherein said supply means further comprises a primary chamber into which fluid, for example water, is arranged to be injected and mixed with the steam, said chamber being provided upstream of said mixing chamber, a higher volume/amount of steam is achieved, and a steam exhaust gas mixture, i.e. steamex having a higher fluid, e.g. water, content and a lower temperature, compared to no fluid, e.g. water, injection. As a consequence of the fluid injection the dew point of the mixture is increased substantially. Thus, by varying the amount of fluid injected into the primary chamber the dew point may be varied. Having a high dew point in the steamex offers the advantage that the steamex can “carry” the energy a further distance, as there is a higher fluid, e.g. water, content in the steamex. The efficiency of the device is thus increased. By injecting the fluid, e.g. water, as a mist preferably having a droplet size of less than 10 microns further increases the efficiency.

By providing a method for producing a gaseous medium comprising steam, said steam being produced from a first fluid medium, energy for heating the first fluid medium being provided by burning a fuel, said fuel being burned in a combustion space, comprising the step of mixing the steam with exhaust gas from combustion of said fuel characterised by the steps of introducing air into said combustion space; heating said air by burning said fuel and providing the exhaust gases and the air at a high flow rate; and mixing the exhaust gases and the air with said steam, a mixture of exhaust gas, steam and air having a very high flow rate, which may be applied for filling up large/deep cavities in a very short time, and which is suitable for extinguishing fires in e.g. coal mines or oil tanks, or extracting e.g. oil sand deep under ground, in which applications the fluid preferably is water.

Preferably the method further comprises the step of injecting fluid into said air in the air introduction step. Thereby a more efficient cooling is achieved. Further the density of the air is increased and hence the evaporation force during combustion.

Preferably the method further comprises the step of prior to mixing the steam with exhaust gas, injecting a fluid into said steam. Thereby a higher volume/amount of steam is achieved, and a steam exhaust gas mixture, i.e. steamex having a higher fluid, e.g. water, content and a lower temperature, compared to no fluid, e.g. water, injection. As a consequence of the fluid injection the dew point of the mixture is increased substantially. Thus, by varying the amount of fluid injected into the primary chamnber the dew point may be varied. Having a high dew point in the steamex offers the advantage that the steamex can “carry” the energy a further distance, as there is a higher fluid, e.g. water, content in the steamex. The efficiency is thus increased. By injecting the fluid, e.g. water, as a mist preferably having a droplet size of less than 10 microns further increases the efficiency.

Correspondingly, by providing a device for producing a gaseous medium comprising steam, said steam being produced from a fluid medium, for example water or oil, energy for heating the fluid medium being provided by burning a fuel, said system comprising an arrangement for mixing the steam with exhaust gas from combustion of said fuel, said device comprising a combustion space and means for burning said fuel, said means being arranged to heat the fluid medium in said combustion space, wherein an air inlet, means for introducing air through the air inlet into the combustion space, said air being arranged to be heated by burning said fuel, and means for providing the exhaust gas and air at a high flow rate, and means for mixing the exhaust gas and the air with said steam, a mixture of exhaust gas, steam and air having a very high flow rate, which may be applied for filling up large/deep cavities in a very short time, and which is suitable for extinguishing fires in e.g. coal mines or oil tanks, or extracting e.g. oil sand deep under ground, in which applications the fluid preferably is water.

Preferably the device further comprises a fluid inlet for injecting a fluid, the fluid preferably being a mist having a droplet size of less than 10 microns, the fluid preferably being water, said inlet being arranged at the air inlet such that the fluid is mixed with the air. Thereby a more efficient cooling of the device is achieved. Further the density of the air is increased and hence the evaporation force during combustion, such that the device becomes more efficient.

Preferably the device further comprises supply means for transferring said steam to the mixing chamber, said means comprising a primary chamber into which fluid, for example water, is arranged to be injected and mixed with the stean), said chamber being provided upstream of said mixing chamber. Thereby a higher volume/amount of steam is achieved, and a steam exhaust gas mixture, i.e. steamex having a higher fluid, e.g. water, content and a lower temperature, comnpared to no fluid, e.g. water, injection. As a consequence of the fluid injection the dew point of the mixture is increased substantially. Thus, by varying the amount of fluid injected into the primary chamber the dew point may be varied. Having a high dew point in the steamex offers the advantage that the steamex can “carry” the energy a further distance, as there is a higher fluid, e.g. water, content in the steamex. The efficiency of the device is thus increased. By injecting the fluid, e.g. water, as a mist preferably having a droplet size of less than 10 microns further increases the efficiency.

By providing a turbine configuration comprising an air inlet, a combustion space arranged downstream of said air inlet, means for introducing air through the air inlet into the combustion space, means for burning a fuel, said air being arranged to be heated by burning said fuel, means for providing the exhaust gas and air at a high flow rate, and rotatable turbine means arranged to be rotated by means of said exhaust gas and air, wherein a fluid inlet for injecting a fluid, e.g. water, preferably a fluid mist, is arranged at the air inlet such that the fluid is mixed with the air, a more efficient cooling of the turbine configuration is achieved. Further the density of the air is increased and hence the evaporation force during combustion, such that the turbine configuration becomes more efficient.

Further advantageous embodiments are set out in the dependent claims.

### DESCRIPTION OF THE DRAWINGS

A better understanding of the present invention will be had upon the reference to the following detailed description when read in conjunction with the accompanying drawings, wherein like reference characters refer to like parts throughout the several views, and in which:

FIG. 1 schematically shows an elevational view partly in cross section of a device for efficient energy transformation by means of a gaseous medium comprising steam according to a first embodiment of the present invention;

FIG. 2 schematically shows a perspective view of a device for efficient energy trans-formation by means of a gaseous medium comprising steam according to a second embodiment of the present invention

FIG. 3 schematically shows a method for extinguishing a fire in a coal mine using the device according to FIG. 2.

FIG. 4 schematically shows a method for extracting oil in oil sand under ground.

### DETAILED DESCRIPTION OF THE INVENTION

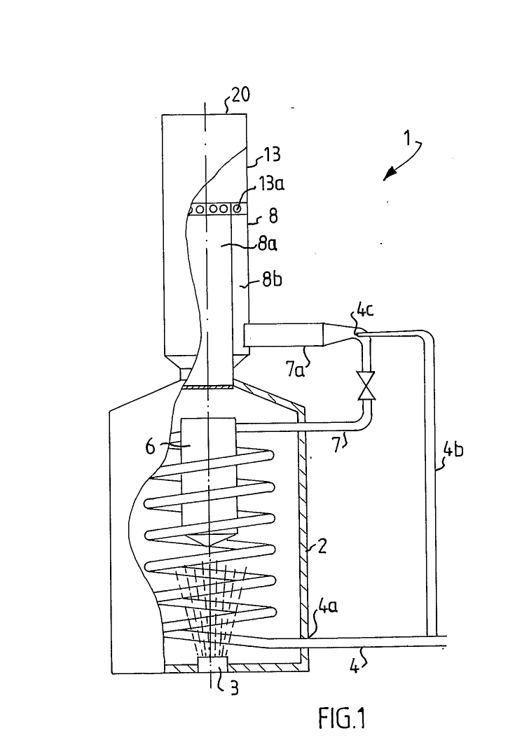

FIG. 1a schematically shows an elevational view partly in cross section of a device for efficient energy transformation by means of a gaseous medium comprising steam according to a first embodiment of the present invention.

The device 1 comprises a primary chamber 2, i.e. a combustion chamber, means for burning a fuel such as a burner 3 for burning said fuel, e.g. a gas burner 3, attached to the bottom of said chamber 2, for introducing heat into said chamber 2, and a fluid inlet 4a at the lower part of the chamber 2, for introducing a fluid, e.g. water into a pipe 4, said pipe 4, when located inside the chamber 2, preferably having a helical shape rising upwardly in the chamber, and a steam chamber 6 to the upper part of which the pipe 4 is connected, in which steam chamber 6 fluid, e.g. water is intended to be introduced and boiled. The chamber 6 further comprises an outlet 7, preferably a pipe 7, in the upper part of the steam chamber 6. An end portion of the pipe 7 constitutes a primary injection chamber 7a into which a cold fluid, e.g. water is intended to be injected. Preferably a branch pipe 4b from the pipe 4 is connected to the primary chamber 7a, the pipe 4b having a nozzle 4c at the end arranged such that when fluid such as water is arranged to flow it is sprayed into the primary chamber 7a. The device further comprises a secondary injection chamber 8 having an inner cavity 8a and an outer cavity preferably coaxially surrounding the inner cavity 8a, said chamber 8 being attached to the top of the chamber 2. The primary chamber 7a is connected to the outer cavity 8b of the secondary injection chamber 8. Steam from said primary chamber 7a is intended to be introduced into the outer cavity 8b of the injection chamber 8 via the pipe 7. The exhaust gas is intended to be introduced into the inner part 8a of the injection chamber 8.

The device further comprises a mixing chamber 13 constituting the downstream part of the injection chamber, where steam, via nozzle like holes/openings 13a in the tube dividing the inner cavity 8a and the outer cavity 8b of the injection chamber 8, is intended to be introduced from the outer cavity 8b of the injection chamber 8. Steam and exhaust gases are thus intended to be mixed in the mixing chamber such that a steam and exhaust gas mixture, hereinafter referred to as steamex, is achieved. The device further comprises an outlet 20 for discharging the steamex.

When operated using water as fluid, water is introduced through the pipe flowing in the helical pipe 4 and is pre-heated by means of the burner 3 and then continues to the steam pressure chamber 6 where the water starts to boil and reaches a high pressure. The pressurised steam, steam having a pressure of e.g. 3 Bar, created continues through the pipe 7 via the valve and enters the primary chamber 7a. Water from the pipe 4b is continuously introduced and sprayed into the primary chamber 7a via the nozzle 4c, the water preferably being a mist having a droplet size of less than 10 microns. The steam in the pipe 7 is e.g. approximately 140° C. and the water sprayed into the primary chamber is e.g. approximately 6° C. The steam and the water mist are mixed in the primary chamber 7a, such that a steam of slightly lower temperature, e.g. approximately 120° C., but with a higher water content is achieved. The flow is thus increased, depending on the amount of water injected, e.g. from approximately 10 m³/min at 140° C. to e.g. approximately 20 m³/min at 120° C. The steam with high water content is introduced/flows into the outer cavity 8b of the secondary injection chamber 8 and flows towards the mixing chamber 13. As the steam flows in the outer cavity 8b it is heated by means of the exhaust gas flowing in the inner cavity 8a of the injection chamber 8 towards the mixing chamber 13, the exhaust gas having a temperature of e.g. approximately 600° C. The steam is heated to a temperature of e.g. 340° C., and consequently expands correspondingly. As the hot steam enters the mixing chamber it will due to the expansion have a high flow rate. The steam enters the mixing chamber through nozzle like holes/openings 13a in the inner tube dividing the inner and outer cavities, the steam having a high flow mixing with the exhaust gas creating a steam and exhaust gas mixture, or steamex. The holes 13a are configured such that an ejector effect is achieved as the steam projects through the same. The ejection has the effect that the steam lifts the exhaust gases or brings the exhaust gases with the steam as they mix, i.e. has a jet suction effect. A depression is thus created such that the combustion continues, i.e. the burning of the fuel is not extinguished. The mixing chamber 13 has a larger cross sectional area than the inner cavity 8a, preferably a cross sectional area corresponding to the sum of the cross sectional area of the inner and outer cavity 8a, 8b.

An alternative to water as fluid may be oil.

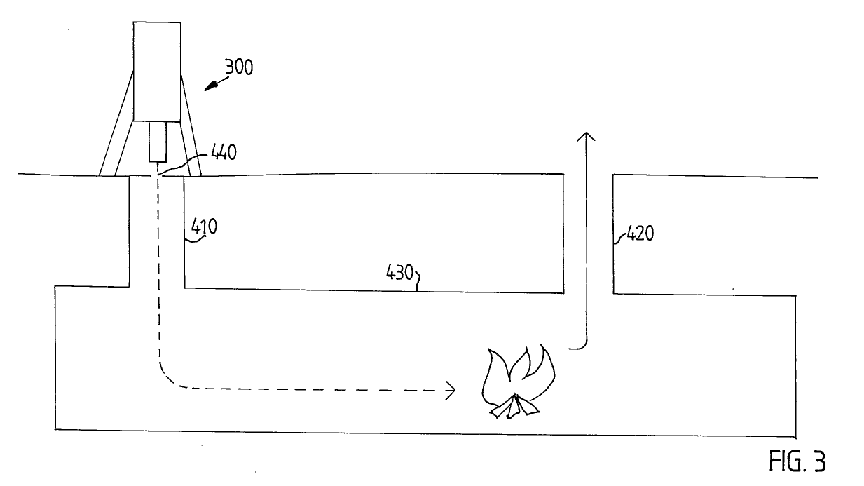

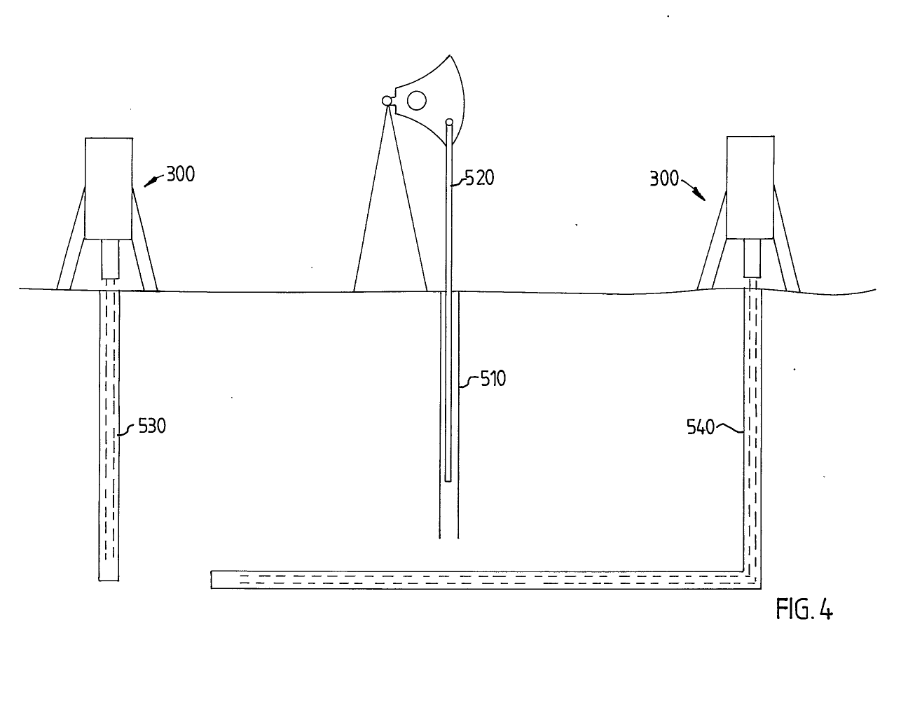

The effect of the water injection, or rather injection of water mist of less than 10 microns, is that a higher volume/amount of steam is achieved, and a steamex having a higher water content, e.g. 96% instead of e.g. 83% without water injection and a lower temperature, e.g. 340-380° C. instead of e.g. 450° C. without water injection. As a consequence of the water injection the dew point is increased a lot, e.g. to 88° C. instead of e.g. 65° C. without water injection. Thus, by varying the amount of water mist injected into the primary chamber the dew point may be varied. Having a high dew point in the steamex offers the advantage that the steamex can “carry” the energy a further distance, as there is a higher water content in the steaniex. The efficiency of the device is thus increased. There are applications where this effect is advantageous, as will be explained below in conjunction with FIGS. 3 and 4.

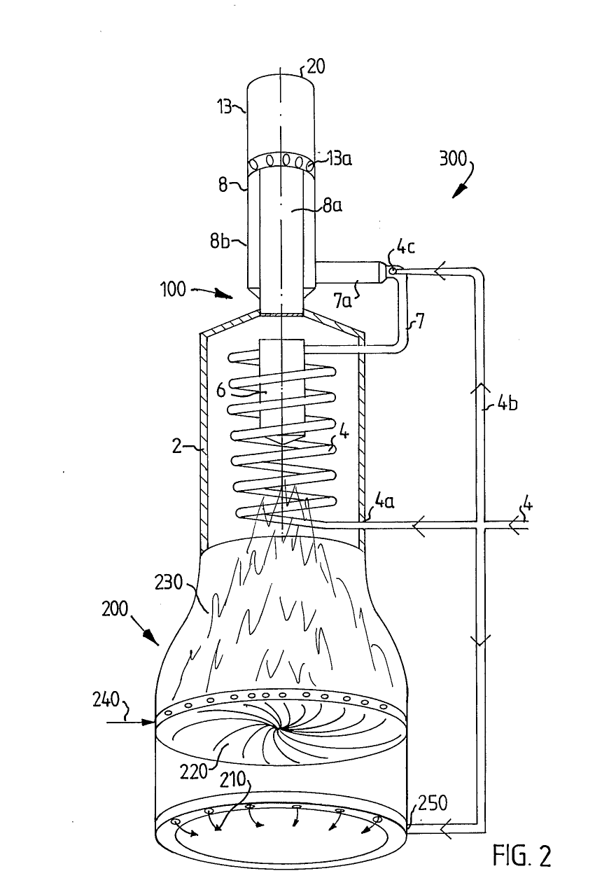

FIG. 2 schematically shows a perspective view of a device 300 for efficient energy transformation by means of a gaseous medium comprising steam according to a second embodiment of the present invention. The device according to the second embodiment is substantially a combination of a gas turbine or the like and the device according to the first embodiment, as will be explained below.

The device according to the second embodiment of the present invention comprises a gas turbine part 200 and a steam/exhaust gas mixture generator part, i.e. a steamex generator part 100. The gas turbine part comprises an air inlet 210, means 220 for sucking air into the gas turbine part such as a fan 220 preferably arranged down-stream of the air inlet, a combustion chamber 230 or similar space/cavity, and means for combusting a fuel within said combustion chamber 230, said fuel preferably being arranged to be introduced into the combustion chamber via a fuel inlet 240. Preferably the gas turbine part comprises compressor means arranged to compress the air sucked in through the air inlet. Preferably the gas turbine part comprises a turbine means, e.g. a turbine wheel, arranged to drive said compressor means by means of a portion of the exhaust gas and air produced in the combustion chamber. Preferably die device comprises a constriction means, e.g. a convergent nozzle or the like, arranged to receive the exhaust gas and air, for accelerating said exhaust gas and air through the same in order to increase the flow rate. The gas turbine part could be any kind of gas turbine having any design suitable for producing exhaust gas of high flow rate, the gas turbine being adaptable with the device according to the first embodiment, or similar device intended to produce steamex. In other words the means for burning the fuel which in FIG. 1 as an example is constituted by a burner 3, here may be constituted by ignition means in a gas turbine, such that a high flow rate of the exhaust gas produced is achieved. Instead of sucking the air into the air inlet by suction means, an alternative way of introducing air is to blow the air into said air inlet by blowing means.

The steamex generator part comprises an outlet 20, a chamber 2, a fluid inlet 4a at the lower part of the chamber 2, for introducing fluid, e.g. water into a pipe 4, said pipe 4, when located inside the chamber 2, preferably having a helical shape rising upwardly in the chamber, and a steam chamber 6 to the upper part of which the pipe 4 is connected, in which steam chamber 6 fluid, e.g. water is intended to be introduced and boiled. The chamber 6 further comprises an outlet 7, preferably a pipe 7, in the upper part of the steam chamber 6. An end portion of the pipe 7 constitutes a primary injection chamber 7a into which a cold fluid, e.g. water is intended to be injected. Preferably a branch pipe 4b from the pipe 4 is connected to the primary chamber 7a, the pipe 4b having a nozzle 4c at the end arranged such that when fluid such as water is arranged to flow it is sprayed into the primary chamber 7a. The device further comprises a secondary injection chamber 8 having an inner cavity 8a and an outer cavity preferably coaxially surrounding the inner cavity 8a, said chamber 8 being attached to the top of the chamber 2. The primary chamber 7a is connected to the outer cavity 8b of the secondary injection chamber 8. Steam from said primary chamber 7a is intended to be introduced into the outer cavity 8b of the injection chamber 8 via the pipe 7.

The steamex generator part of the device is arranged downstream of the combustion chamber 230 such that the heat from the burning fuel in the combustion chamber heats up the pipe configuration 4 in the chamber 2, into which a fluid, e.g. water is intended to be introduced and flow. The exhaust gas is intended to be introduced into the inner part 8a of the injection chamber 8. Preferably fluid, e.g. water, more preferably fluid mist, e.g. water mist, having a droplet size of less than 10 microns, is arranged to be introduced into the turbine part 200 through a fluid inlet 250 preferably located at the air inlet 210 side of the turbine part 200, such that the mist is mixed with the air. The mist of less than 10 microns is e.g. accomplished by means of a nozzle. This has the advantage that the working temperature in the combustion chamber of the turbine part may be controlled. Further, as the density of the air, i.e. the water content in the air, is increased the evaporation force is increased during combustion. Preferably the air is arranged to be filtered prior to entering the turbine part.

When operated air is continuously introduced, e.g. sucked, into the turbine part 200 through the air inlet 210 by means of e.g. the fan 220. The air is heated in the combustion chamber 230 by means of burning means, such that the air expands. The gas of exhaust gas and air is directed towards the mixing chamber 13 at a high velocity. Preferably the air is compressed by means of compressor means after having been introduced into the air inlet, giving the air a higher pressure. Preferably fuel is injected through the fuel inlet 240 and mixed with the compressed air and is ignited by ignition means internally, i.e. in the combustion chamber 230. Substantially all of the air is heated and expands rapidly. It exhaust as a high velocity gas, i.e. exhaust gas and air, preferably through a constriction means, for example a convergent nozzle. Preferably at least a portion of the gas is directed towards a turbine means, e.g. a blade of a turbine wheel, the energy created being used to drive the compressor means, the remaining portion being directed towards the mixing chamber 13.

When, as en example, using water as fluid, water is continuously introduced through the pipe, flowing in the helical pipe 4 and is pre-heated by means of the burning fuel in the combustion chamber 230 and then continues to the steam pressure chamber 6 where the water starts to boil and reaches a high pressure. The pressurised steam created continues through the pipe 7 via the valve and enters the primary chamber 7a. Water from the pipe 4b is continuously introduced and sprayed into the primary chamber 7a via the nozzle 4c, the water preferably being a mist of less than 10 microns. The steam in the pipe 7 is e.g. approximately 140° C. and the water sprayed into the primary chamber is e.g. approximately 6° C. The steam and the water mist are mixed in the primary chamber 7a, such that a steam of slightly lower temperature, e.g. approximately 120° C., but with a higher water content is achieved. The flow is thus increased from e.g. approximately 10 m³/min at 140° C. to e.g. approximately 20 m³/min. The steam with high water content is introduced/flows into the outer cavity 8b of the secondary injection chamber 8 and flows towards the mixing chamber 13. As the steam flows in the outer cavity 8b it is heated by means of the exhaust gas flowing at a high flow rate in the inner cavity 8a of the injection chamber 8 towards the mixing chamber 13, the exhaust gas, having a temperature of e.g. approximately 600° C. The steam is heated to a temperature of e.g. 340° C., and consequently expands correspondingly. As the hot steam enters the mixing chamber it will due to the expansion have a high flow rate. The steam enters the mixing chamber through holes or the like in the inner tube dividing the inner and outer cavities, the steam having a high flow rate mixing with the exhaust gas having a very high flow rate, and hence high pressure when introduced into a cavity, creating a steam and exhaust gas mixture, or steamex, with a very high flow rate/high pressure.

The effect of the fluid, e.g. water injection, or rather injection of fluid, e.g. water mist of less than 10 microns, into the primary chamber 7a is that a higher volume/amount of steam is achieved, and a steamex having a higher water content, e.g. 96% instead of e.g. 83% without water injection and a lower temperature, e.g. 340-380° C. instead of e.g. 450° C. without water injection. As a consequence of the water injection the dew point is increased a lot, e.g. to 88° C. instead of e.g. 65° C. without water injection. Thus, by varying the amount of water mist injected into the primary chamber the dew point may be varied. Having a high dew point in the steamex offers the advantage that the steamex can “carry” the energy a further distance, as there is a higher water content in the steamex. By means of the gas turbine part, exhaust gas at high pressure/high flow rate is produced, which facilitates trans-porting the steamex long distances at high velocity/high pressure, where the high dew point of the steamex, i.e. the high water content in the hot steamex the energy content is preserved, i.e. energy losses are reduced. Due to the high pressure and high flow rate achieved, the device facilitates filling up large cavities in short time. There are applications where the above effects are advantageous, as will be explained below, in conjunction with FIGS. 3 and 4.

The water injected at the water mist inlet 250 may be fed from the same source as the water fed to and injected into the primary injection chamber 7a and the inlet 4a into the chamber 2 of the steamex generator part, or water may be fed from separate sources. Preferably there are control means in order to control the flow of water to the inlets 4a, 7a, 250.

Instead of a gas turbine or gas turbine like device, any kind of means for achieving a high flow rate of exhaust gas for heating steam and be mixed by said steam may be used, such as e.g. a gas generator or the like.

In the same manner as for the gas turbine part of the device according to the second embodiment, shown in FIG. 2, any type of gas turbine may be provided with a water injection device intended for injection of water, preferably water mist of less than 10 microns, arranged such that the injected water mist is mixed with the air sucked into the gas turbine such that a cooling effect within the turbine is achieved.

FIG. 3 schematically shows a method for extinguishing a fire in a coal mine using the device according to FIG. 2. FIG. 3 thus shows an application for the device according to the second embodiment of the present invention.

FIG. 3 schematically shows a coal mine having two shafts 410, 420 leading to a mine 430 located under ground, the mine constituting a large cavity in which there is a fire. In such a case one of the shafts 420 will function as a gas evacuation for smoke from said fire and in the other shaft 410 oxygen from the ambient air outside will be sucked down, feeding the fire. In order to solve the problem of extinguishing such a fire the device 300 according to the second embodiment is used. The opening of the shaft through which the air is sucked into the mine is arranged to be sealed in such a way that only a small opening 440 is present. The device 300 is arranged in connection to said opening in such a way that steamex produced by the device, the device functioning in the manner described above, may be introduced, the steamex replacing the oxygen sucked down. Due to the high pressure and high flow rate of the steamex, the oxygen is removed/pushed away and the fire is extinguished by the steamex of high water content. The device thus provides a method for extinguishing fires in coal mines or the like from outside of the mine. There is no need to enter the mine.

Similarly fires in oil storage tanks at land or sea may be extinguished by means of the device 300.

FIG. 4 schematically shows a method for extracting oil in oil sand under ground. FIG. 4 schematically shows an oil bore hole 510 into which an oil pump 520 is intended to be introduced in order to pump up oil. When the oil is in the form of oil sand, steam is conventionally introduced into holes 530, 540, e.g. two holes arranged respectively at a distance from the oil bore hole 510 as is suggested in FIG. 4. The oil sand, when heated becomes fairly liquid and thus finds the bore hole from where it is pumped. Instead of applying a conventional steam generator, the device 300 according to the second embodiment is used. A device 300 is arranged respectively over each hole into which steam is intended to be introduced. Alternatively one device could be arranged to supply both holes. The device 300 is arranged in connection to the opening of the holes 530, 540 in such a way that steamex produced by the device, the device functioning in the manner described above, may be introduced. The device 300, as it uses the exhaust gases, is much more efficient, i.e. need much less power compared to conventional steam generators. Further the device produces much more steamex per time unit than steam per time unit produced by a conventional steam generator. Due to the high energy content, i.e. the high dew point/high water content of the produced hot steamex it may be transported far keeping the energy content. The conventional steam generators are used in holes up to 2 km. With the device 300 according to the invention excavation of oil sand at larger depths, e.g. more than 3 km may be achieved.

Preferably, prior to injecting the steamex by means of the device 300, water is arranged to be introduced into the bore holes such that the ground/soil at the bottom of the holes is saturated, i.e. the water has been sucked into the ground such that the ground is wet. When the ground/soil is saturated by water the energy is transferred quicker to the oil such that the excavation becomes more efficient.

The device 300 may also be used in other applications. A similar application to the one shown in FIG. 4 is for example clearance or decontamination of areas where the ground is contaminated by chemicals, where the chemicals may be heated by means of the steamex produced by the device, which chemicals than may be drained to bore holes and pumped such that they are removed. The device may also be applied in sky scrapers in order to put out fires.

Where temperatures, pressures, efficiencies are mentioned they have been included for the purpose of increasing the intelligibility of the application and are only examples and do consequently not have any limiting effect on the interpretation of each element.

Where technical features mentioned in any claim are followed by reference signs, those reference signs have been included for the sole purpose of increasing the intelligibility of the claims and accordingly, such reference signs do not have any limiting effect on the interpretation of each element identified by way of example by such reference signs.

1. A method for producing a gaseous medium comprising steam, said steam being produced from a first fluid medium, energy for heating the first fluid medium being provided by burning a fuel, the method comprising:
mixing the steam with exhaust gas from combustion of said fuel; and
prior to mixing the steam with exhaust gas, injecting fluid into said steam.

2. The method according to claim 1, wherein the steam in the injection of fluid step is provided under pressure.

3. The method according to claim 1, wherein the fluid is injected as a mist having a droplet size of less than 10 microns.

4. The method according to claim 3, wherein the fluid is water.

5. A device for producing a gaseous medium comprising steam, said steam being produced from a fluid medium, energy for heating the fluid medium being provided by burning a fuel, said system comprising
a mixing space to mix the steam with exhaust gas from combustion of said fuel,
a supply to transfer said steam to the mixing space, a combustion space, and
a burner to burn said fuel, said burner being arranged to heat the fluid medium in said combustion space,
wherein said supply comprises a primary chamber into which fluid is arranged to be injected and mixed with the steam, said chamber being provided upstream of said mixing chamber.

6. The device according to claim 5, wherein the supply comprises a pressure chamber from which steam is extracted, arranged upstream of the primary chamber such that pressurized steam is arranged to enter the primary chamber.

7. The device according to claim 6, further comprising a nozzle for spraying the fluid into the primary chamber.

8. The device according to claim 7, wherein the fluid is arranged to be atomized to a mist having a droplet size of less than 10 microns.

9. The device according to claim 8, wherein the fluid is water.

10. A method for producing a gaseous medium comprising steam, said steam being produced from a first fluid medium, energy for heating the first fluid medium being provided by burning a fuel, said fuel being burned in a combustion space, the method comprising:
mixing the steam with exhaust gas from combustion of said fuel;
introducing air into said combustion space;
heating said air by burning said fuel and providing the exhaust gases and the air at a high flow rate; and
mixing the exhaust gases and the air with said steam.

11. Method according to claim 10, further comprising the step of compressing the air prior to introducing the air into the combustion space.

12. The method according to claim 11, further comprising the step of injecting fluid into said air in the air introduction step.

13. The method according to claim 10, wherein the fluid is injected as a mist having a droplet size of less than 10 microns.

14. The method according to claim 10, wherein the fluid is water.

15. The method according to claim 10, further comprising prior to mixing the steam with exhaust gas, injecting a fluid into said steam.

16. The method according to claim 15, wherein the steam in the injection of fluid step is provided under pressure.

17. The method according to claim 15, wherein the fluid is injected as a mist having a droplet size of less than 10 microns.

18. The method according to claim 15, wherein the fluid is water.

19. A device for producing a gaseous medium comprising steam, said steam being produced from a fluid medium, for example water or oil, energy for heating the fluid medium being provided by burning a fuel, said device comprising:
a mixing space to mix the steam with exhaust gas from combustion of said fuel,
an outlet to discharge said mixture,
a combustion space,
a burner to burn said fuel, said burner being arranged to heat the fluid medium in said combustion space,
an air inlet to introduce air through the air inlet into the combustion space, said air being arranged to be heated by burning said fuel,
a flow device to provide the exhaust gas and air at a high flow rate, and
a mixer to mix the exhaust gas and the air with said steam.

20. A device according to claim 19, further comprising a compressor to compress said air arranged upstream of said combustion chamber.

21. A device according to claim 20, further comprising a turbine arranged to drive said compressor by means of a portion of the exhaust gas and air.

22. A device according to claim 19, further comprising a constrictor arranged to accelerate the exhaust gas en air towards the outlet.

23. A device according to, further comprising a fluid inlet for injecting a fluid, said inlet being arranged at the air inlet such that the fluid is mixed with the air.

24. A device according to claim 23, wherein the fluid inlet is to inject a mist having a droplet size of less than 10 microns.

25. A device according to claim 24, wherein the fluid is water.

26. A device according to claim 19, further comprising a supply to transfer said steam to the mixing chamber, said supply comprising a primary chamber into which fluid is arranged to be injected and mixed with the steam, said chamber being provided upstream of said mixing chamber.

27. A device according to claim 26, wherein the supply comprises a pressure chamber from which steam is extracted, arranged upstream of the primary chamber such that pressurized steam is arranged to enter the primary chamber.

28. A device according to claim 26, further comprising a sprayer to spray the fluid into the primary chamber.

29. A device according to claim 28, wherein the fluid is arranged to be atomized to a mist having a droplet size of less than 10 microns.

30. A device according to claim 26, wherein the fluid is water.

31. A method for extinguishing a fire in a cavity, for example a mine or an oil tank, comprising:
injecting into said cavity the gaseous medium produced by means of the device according to claim 19.

32. A method for extracting oil, for example shale oil or oil sand, buried under ground, comprising:
providing a bore hole;
providing at least one hole for heating the oil;
introducing a hot medium into the at least one hole for heating the oil such that it becomes sufficiently fluid to be pumped up;
pumping the oil through the bore hole; and
providing said hot medium by the gaseous medium produced by the device according to claim 19.

33. A method according to claim 32,
wherein prior to introducing the gaseous mixture comprising steam and exhaust gas, introducing water into said at least one hole for heating;
allowing the water introduced into said to sink into the ground at the bottom of said at least one hole such that the ground is saturated.

34. Turbine configuration comprising an air inlet, a combustion space arranged downstream of said air inlet, means for introducing air through the air inlet into the combustion space, means for burning a fuel, said air being arranged to be heated by burning said fuel, means for providing the exhaust gas and air at a high flow rate, and rotatable turbine means arranged to be rotated by means of said exhaust gas and air, characterised in a fluid inlet for injecting a fluid, e.g. water, preferably a fluid mist, said inlet being arranged at the air inlet such that the fluid is mixed with the air.

35. The method according to claim 2, wherein injecting fluid into said steam includes injecting under pressure.

36. The method according to claim 35, wherein injecting includes injecting a mist having a droplet size of less than 10 microns.

37. The method according to claim 1, wherein injecting includes injecting water.
